(19) United States
(12) Patent Application Publication
(10) Pub. No.: US 2026/0145791 A1
(43) Pub. Date: May 28, 2026

(54) Fire-fighting Tank Arrangement

(71) Applicants: Airbus Operations GmbH, Hamburg (DE); Airbus Operations SAS, Toulouse (FR)

(72) Inventors: Volker Robrecht, Hamburg (DE); Pierre Gambier, Toulouse (FR)

(73) Assignees: Airbus Operations GmbH, Hamburg (DE); Airbus Operations SAS, Toulouse (FR)

(21) Appl. No.: 19/391,467

(22) Filed: Nov. 17, 2025

(30) Foreign Application Priority Data
Nov. 28, 2024 (DE) 102024135269.8

(51) Int. Cl. B64D 1/16; A62C 3/02; A62C 35/02

(52) U.S. Cl. CPC B64D 1/16; A62C 3/0242; A62C 35/023

(57) ABSTRACT

A fire-fighting tank arrangement for a fire-fighting aircraft includes a tank structure with at least two storage units arranged within the tank structure, a collecting conduit, and a tank outlet. The at least two storage units are each configured to store an extinguishing agent temporarily. Each storage unit includes a primary portion and a secondary portion. The secondary portion provides a tapering transition from the primary portion to a storage unit outlet. Each of the storage unit outlets is connected to the collecting conduit that is configured to provide a flow of the extinguishing agent towards the tank outlet. The tank outlet is configured to discharge the extinguishing agent to a selected target. Adjacent primary portions of the at least two storage units are provided with a fluid connection.

### CROSS-REFERENCE TO RELATED APPLICATIONS

The present application claims priority from German Application No. 102024135269.8 filed November 28, 2024, the disclosure of which is hereby incorporated herein by reference.

### FIELD OF THE INVENTION

The present invention relates to a tank arrangement for fire-fighting aircrafts and to a method to rebuild a passenger aircraft in a fire-fighting aircraft using the tank arrangement as well as to a method for extinguishing a fire using a fire-fighting aircraft.

### BACKGROUND OF THE INVENTION

Tanks for fire-fighting aircrafts are commonly small tanks which are installed in the cargo compartment. In principle there are several types for tanks possible: external tanks, pure pressurized tanks, pure gravity tanks and a combination of gravity and pressurized tanks. However, tanks commonly used for fire-fighting aircrafts are an arrangement of several single tanks which are connected. However, these kinds of arrangements have issues in their effect on the resulting center of gravity of the aircraft due to constraints in the positioning of the tanks. Furthermore, these kinds of arrangements have also been shown to result in non-optimal use of space.

### SUMMARY OF THE INVENTION

There may thus be a need to provide an improved tank arrangement.

The object of the present invention is solved by the subject-matter of the independent claims; further embodiments are incorporated in the dependent claims. It should be noted that the following described aspects of the invention apply also for the fire-fighting aircraft, for the method of building a fire-fighting aircraft and for the method for extinguishing a fire.

According to the present invention, a fire-fighting tank arrangement for a fire-fighting aircraft is provided. The tank arrangement comprises a tank structure, at least two storage units arranged within the tank structure, a collecting conduit and a tank outlet. The at least two storage units are each configured to store an extinguishing agent temporarily. Each storage unit comprises a primary portion and a secondary portion. The secondary portion provides a tapering transition from the primary portion to a storage unit outlet and each of the storage unit outlets is connected to the collecting conduit that is configured to provide a flow of the extinguishing agent towards the tank outlet. The tank outlet is configured to discharge the extinguishing agent to a selected target and adjacent primary portions of the at least two storage units are provided with a fluid connection.

As an effect, the tank structure using interconnected storage units enhances the using of space while maintaining an optimal center of gravity of the fire-fighting aircraft.

In an option, the center of gravity is as low as possible in a fighting aircraft.

According to an example, for the fluid connection, an adjustable separating rib is provided between the adjacent primary portions of the at least two storage units.

According to an example, the adjustable separating rib is configured to be moveable by translational movement or pivoting movement.

Translational movement means that the fluid connection of the storage unit may be enabled or disabled depending on the position of the separating rib in translational direction. Pivoting movement means that the separating rib is pivotable to either one of the primary portions of the at least two storage units means that the rib may pivot to either of the primary portions of the at least two storage units. This pivoting alters the volumes of the at least two storage units, as the volume of the primary portions of the at least two storage units changes. Furthermore, the stored extinguishing agent may flow between the different primary portions, wherein this flowing may be used for changing a center of gravity of the fire-fighting aircraft or to enable an adjustable discharge of the extinguishing agent through an adjustable flow rate.

As an advantage, the adjustable separating rib is configured to be moveable by a rotating movement.

According to an example, a shape of the primary portions is cylindrical, having a horizontal circular cross-section or angular, having flat surfaces meeting at distinct edges and vertices.

As an advantage, the storage units also have an uniform longitudinal axis. This uniform longitudinal axis may be perpendicular to a longitudinal axis of the fire-fighting aircraft.

According to an example, the collecting conduit comprises a main pipe and a plurality of pipe segments. The pipe segments connect the storage unit outlets with the main pipe. As an option, the collecting conduit comprises an outlet pipe segment that connects the main pipe with the tank outlet.

According to an example, the material of the storage unit and the collecting conduit is formed from aluminum or composite.

According to an example, the material of the storage unit and the collecting conduit is formed from any material with similar material properties as aluminum or composite to store and transport an extinguishing agent.

According to the present invention, a fire-fighting aircraft comprises a fuselage structure and a fire-fighting tank arrangement according to one of the preceding examples. The fuselage structure encloses an inner space, and the fire-fighting tank arrangement is located in the inner space.

According to an example, the fire-fighting aircraft further comprises a wing box and the inner space comprises a floor that separates a lower section located below the floor and an upper section located above the floor. The wing box is located in the lower section and the tank arrangement is located in the upper section above the wing box.

In an option, the collecting conduit of the tank arrangement is located in the upper section.

In an option, the tank arrangement is formed to have a shape of the upper section.

As an effect, the tank arrangement uses an entire space of the fuselage structure, and the fire-fighting aircraft can load as much extinguishing agent as possible.

According to an example, the fire-fighting aircraft comprises one or a plurality of cargo doors. The cargo doors are arranged in the fuselage dividing the inner space from the outer environment.

According to the present invention, also a method for building a fire-fighting aircraft is provided. The method comprises the following steps:

Loading a tank arrangement according to the preceding examples in a fuselage of the fire-fighting aircraft;

Arranging the tank arrangement in an upper section of the fuselage; and

Installing the tank arrangement in the fire-fighting aircraft.

According to an example, the method further comprises the following step, provided before the step of the Arranging:

Dismantling a fuselage of a passenger aircraft and removing seats and components only related to the passenger aircraft.

According to the present invention, also a method for extinguishing a fire using a fire-fighting aircraft according to one of the preceding examples is provided. The method comprises the following steps:

Identifying a fire location.

During flight, discharging at least a part of an extinguishing agent stored in the at least two storage units through the collecting conduit and the tank outlet.

According to an example, the method further comprising the following step, provided before the step of Discharging:

Activating the extinguishing agent stored in the tank arrangement

According to an example, the discharging of the extinguishing agent is using gravity or a pump system.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows an example of a storage unit in a plan view.

FIG. 2 shows an example of the storage unit of FIG. 1 with a separating rib in a plan view.

FIG. 3 shows a tank arrangement according to the present invention in a plan view.

FIG. 4 shows a fire-fighting aircraft according to the present invention in a plan view.

FIG. 5 shows a flow chart of a method for building a fire-fighting aircraft

FIG. 6 shows a flow chart of a method for extinguishing a fire using a fire-fighting aircraft.

### DETAILED DESCRIPTION OF EMBODIMENTS

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the exemplary embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

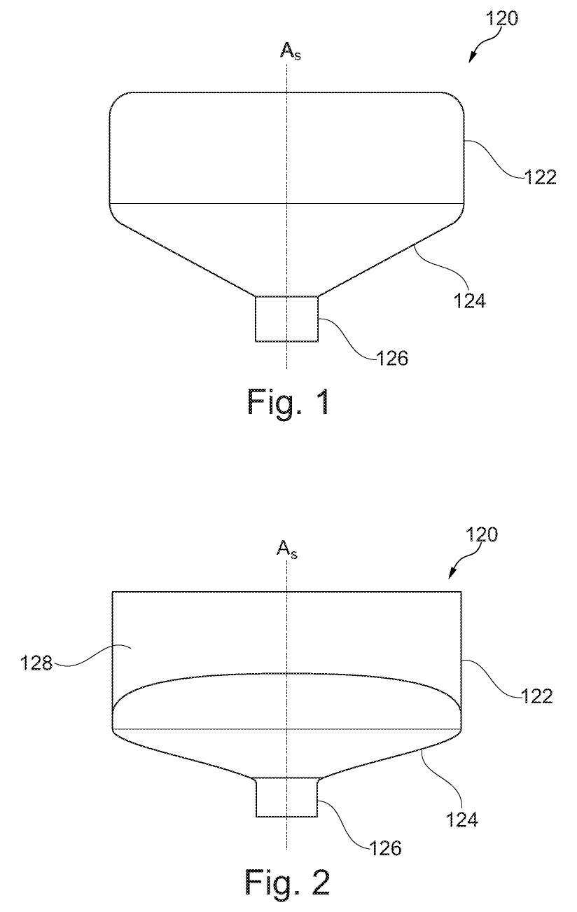

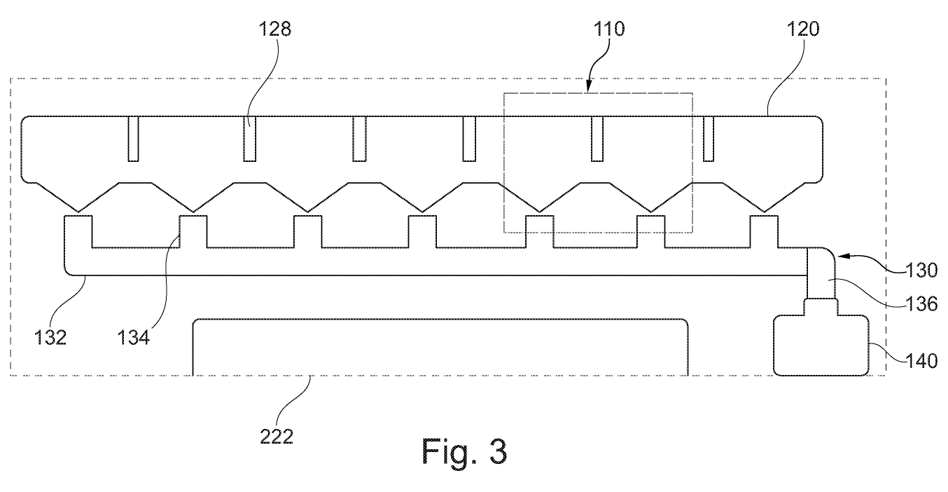

FIGS. 1 to 3 schematically show an example of a fire-fighting tank arrangement 100 in a fire-fighting aircraft in a vertical section. The tank arrangement 100 in FIG. 3 is shown in the context of an example of a fire-fighting aircraft. The tank arrangement 100 comprises a tank structure 110, at least two storage units 120 arranged within the tank structure 110, a collecting conduit 130 and a tank outlet 140. The at least two storage units 120 are each configured to store an extinguishing agent (not shown) temporarily.

In FIG. 1, each storage unit 120 comprises a primary portion 122 and a secondary portion 124. The secondary portion 124 provides a tapering transition from the primary portion 122 to a storage unit outlet 126 and each of the storage unit outlets 126 is connected to the collecting conduit 130 that is configured to provide a flow of the extinguishing agent towards the tank outlet 140. The tank outlet 140 is configured to discharge the extinguishing agent to a selected target and adjacent primary portions 122 of the at least two storage units 120 are provided with a fluid connection.

In FIG. 1, the storage unit 120 is a closed unit, wherein the primary portion 122 is arranged above the secondary portion 124, related to the direction in the Figure, and the storage unit outlet 126 is arranged below the secondary portion 124.

The term “fire-fighting aircraft” 200 relates to an aircraft for extinguishing fire. The fire-fighting aircraft can also be referred to an aircraft. In an example, the fire-fighting aircraft 200 is built via rebuilding a passenger aircraft.

The term “tank structure” relates to a loading unit to load a specific load, comprising several relating tanks 120 e.g. coupled in row, that are divided by ribs.

The tank structure 110 can also be referred to a mono-tank. In an example, the tank structure 110 is loading an extinguishing agent (not shown).

The term “storage unit” relates to store an extinguishing agent for fire-fighting as an cylindric container. The storage unit 120 can also be formed as an angular container. The storage unit can also be referred to a fire-fighting tank. The storage unit can also be referred to a vessel. In an example, the storage unit 120 is connectable to a collecting conduit 130.

The term “collecting conduit” relates to a pipeline arrangement that is provided to transport the agent stored in the container using gravity. The collecting conduit can also be referred to as pipework, as pipe or as piping. In an example, the collecting conduit is connected to the at least two storage units 120 and the tank outlet 140.

The term “tank outlet” relates to a hole for discharging the extinguishing agent from the tank outside the aircraft. In an example, the tank outlet 140 is connected to the collecting conduit 130. Throughout the tank outlet 140, the extinguishing agent may be discharged by the use of gravity or a pump system.

The term “extinguishing agent” relates to a substance used to suppress, control, or extinguish a fire by disrupting one or more of the essential elements of combustion, such as heat oxygen or the chemical chain reaction. The extinguishing agent can be in a liquid state, a pressurized gas state or another state suitable for a fire-fighting tank in an aircraft.

The term “tapering transition” relates to the transition from the primary portion 122 to the storage unit outlet 126. The tapering transition comprises a specific angle extending to the storage unit outlet 126. This angle can differ according to a desired flow rate of the extinguishing agent during discharge. Furthermore, this angle is required in a system, where discharging is performed with gravity.

In an option of the example of FIG. 1 to 3, the discharging may be performed with a pump system. A pump system does not require such an angle.

FIG. 2 schematically shows an example of the storage unit from FIG. 1, wherein for the fluid connection, and an adjustable separating rib 128 is provided. The separating rib 128 is provided between the adjacent primary portions 122 of the at least two storage units 120. (FIG. 3)

The term “fluid connection” relates to a transition of the primary portions of the at least two storage units, wherein the extinguishing agent may flow from one storage unit to the other.

In an option of the example of FIG. 2, the separating rib 128 is configured to be moveable by translational movement or by pivoting movement.

Translational movement means that the fluid connection of the storage units 120 may be enabled or disabled depending on the position of the rib 128 in translational direction.

Pivotable to either one of the primary portions 122 of the at least two storage units 120 means that the rib 128 may pivot to either of the primary portions 122 of the at least two storage units 120. This pivoting alters the volumes of the at least two storage units 120, as the volume of the primary portions 122 of the at least two storage units 120 changes. Furthermore, the stored extinguishing agent may flow between the different primary portions 122, wherein this flowing may be used for changing a center of gravity of the fire-fighting aircraft or to enable an adjustable discharge of the extinguishing agent through an adjustable flow rate.

In an option of the example of FIG. 2, the separating ribs 128 may also be configured to rotate between the primary portions 122 of the at least two storage units 120.

This adjustment of the separating ribs allows to influence the flow rate during discharging the extinguishing agent. Furthermore, this adjustment allows the controlled flow of the extinguishing agent during flight, according to a filling level in the tank structure 110.

In FIG. 1 and FIG. 2, the shape of the primary portions 122 is cylindrical, having a horizontal circular cross-section.

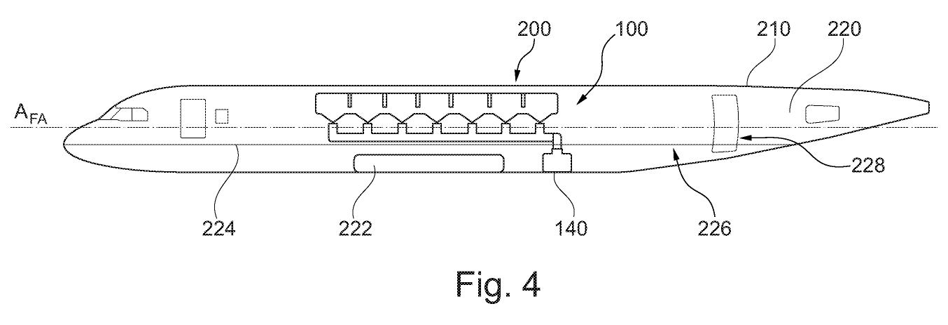

The term “cylindrical” means that the shape of the primary portions 122 of the at least two storage units 120 is cylindrical that the at least two storage units 120 are formed as a cylinder having a diameter and a circular circumference. The storage units 120 have a horizontal circular cross-section and a uniform longitudinal axis A_{S}, wherein the longitudinal axis A_{S} is perpendicular to a longitudinal axis A_{AF} of the fire-fighting aircraft (FIG. 4).

The circumference is formed around the longitudinal axis A_{S}.

The storage units may be formed out of thin metal sheets. The thickness of a formed wall formed of the sheets may vary according to the stored extinguishing agent and the required features.

In FIG. 2, the separating rib 128 is extending through the entire cross-section of the primary portion 122 of the storage unit 120.

In an option of the example of FIG. 1 and 2, the shape of the primary portions 122 may be angular, having flat surfaces meeting at distinct edges and vertices.

The term “angular” means that the shape of the at least two storage units 120 may be angular with each storage unit 120 formed as rectangular block, wherein the rectangular block includes a length, a width and a height, wherein the dimensions of the length, the width and the height may be either different or the same size. The angular storage units 120 may have flat surfaces meeting at distinct edges and vertices, forming a polyhedral structure.

In an option of the example of FIG. 1, the shape of the storing units may also be different to a cylindric or angular shape, preferably fitting into the fire-fighting aircraft.

FIG. 3 schematically shows the tank arrangement.

In the example of FIG. 3, the collecting conduit 130 comprises a main pipe 132 and a plurality of pipe segments 134. The pipe segments 134 connect the storage unit outlets 126 with the main pipe 132.

In an option, the collecting conduit 130 comprises an outlet pipe segment 136 that connects the main pipe 132 with the tank outlet 140, as shown in FIG. 3.

In FIG. 3, the collecting conduit 130 is arranged below, related to the direction in the Figure, the tank structure 110. This is required for discharging the extinguishing agent with gravity. The pipe segments 134 are connected to the storage unit outlets 126. The storage unit outlet 126 is arranged below a center of the secondary portion 124 of the storage unit 120 and is formed around the longitudinal axis A_{S}.

In an option of the example of FIG. 3, the collection conduit 130 may be arranged above the tank structure 110, wherein such a configuration requires a pump system.

The cross-section of the main pipe 132, the pipe segments 134 and the outlet pipe segment 136 is circular in the example of FIG. 3. The size of the cross-section may depend on the desired flow rate. The bigger the cross-section is the faster is the flow rate.

FIG. 4 shows a fire-fighting aircraft 200. The fire-fighting aircraft 200 comprises a fuselage structure 210 and the fire-fighting tank arrangement 100. The fuselage structure encloses an inner space 220 and the fire-fighting tank arrangement 100 is located in the inner space 220.

In FIG. 4, the fire-fighting aircraft 200 further comprises a wing box 222. The inner space 220 comprises a floor 224 that separates a lower section 226 located below the floor 224, related to the figure, and an upper section 228 located above the floor 224. The wing box 222 is located in the lower section 226 and the tank arrangement 100 is located in the upper section 228 above the wing box.

In an option, the collecting conduit 130 of the tank arrangement 100 is located in the upper section 228.

In an option of the example of FIG. 4, the tank arrangement 100 is formed to have a shape of the upper section 128.

In an option of the example of FIG. 4, the fire-fighting aircraft 200 comprises a plurality of cargo doors, wherein the cargo doors are arranged in the fuselage 210 dividing the inner space 220 from the outer environment.

In FIG. 4, the fire-fighting aircraft 200 comprises a circular cross-section and a longitudinal axis A_{AF}, wherein the circular cross-section and a circular circumference of the aircraft 200 is formed around the longitudinal axis A_{AF}.

In FIG. 4, the tank structure 110 is arranged, that the longitudinal axis A_{S} of one storage unit 120 is perpendicular to the longitudinal axis A_{AF} of the aircraft.

In an option of FIG. 4, the arrangement may vary and the longitudinal axis A_{S} of the storage unit 120 may not be perpendicular the longitudinal axis of the aircraft A_{AF}.

In an option of FIG. 4, the cross-section of the aircraft may vary and be different to a circle.

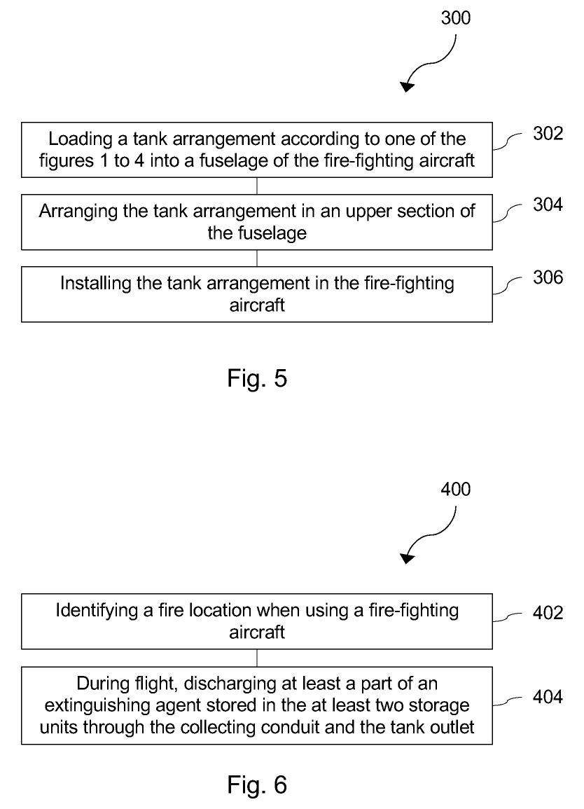

FIG. 5 shows basic steps of an example of a method 300 building a fire-fighting aircraft. The building method 300 comprises the following steps:

In a first step 302, a tank arrangement according to one of the preceding examples is loaded into a fuselage of the fire-fighting aircraft;

In a second step 304, the tank arrangement is arranged in an upper section of the fuselage; and

In a third step 306, the tank arrangement is installed in the fire-fighting aircraft.

In an option of the example of FIG. 5, the method further comprises the following step, provided before the first step 302:

In a further step 301, a fuselage of a passenger aircraft is dismantled and seats and components only related to the passenger aircraft are removed.

In another option of the example of FIG. 5, there may be additional steps according to the kind of aircraft, that has to be rebuilt to a fire-fighting aircraft.

As an advantage, there is a rebuilding kit provided to rebuild each aircraft, such as passenger aircraft, cargo aircraft or any other to a fire-fighting aircraft.

FIG. 6 shows basic steps of an example of a method 400 for extinguishing a fire with a fire-fighting aircraft. The extinguishing method 400 comprises the following steps:

In a first step 402, a fire location is identified; and

In a second step 404, during a flight, at least a part of an extinguishing agent stored in the at least two storage units is discharged through the collecting conduit and the tank outlet.

In an option of the example of FIG. 6, the method further comprises the following step provided before the second step 404:

In a further step 403, the extinguishing agent stored in the tank arrangement is activated.

This activation relates to the kind of extinguishing agent. It depends on the aggregate state and the possibilities of use of the extinguishing agent.

It has to be noted that embodiments of the invention are described with reference to different subject matters. In particular, some embodiments are described with reference to method type claims whereas other embodiments are described with reference to the device type claims. However, a person skilled in the art will gather from the description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

### Reference Numbers

100 fire-fighting tank arrangement/ tank arrangement

110 tank structure

120 storage unit

122 primary portion

124 secondary portion

126 storage unit outlet

128 separating rib

130 collecting conduit

132 main pipe

134 pipe segments

136 outlet pipe segment

140 tank outlet

200 fire-fighting aircraft

210 fuselage structure

220 inner space

222 wing box

224 floor

226 lower section

228 upper section

300 building method

301 dismantling

302 loading

304 arranging

306 installing

400 extinguishing method

402 identifying

403 activating

404 discharging

A_{S} longitudinal axis storage unit

A_{FA} longitudinal axis aircraft/fire-fighting aircraft

1. A fire-fighting tank arrangement for a fire-fighting aircraft, the tank arrangement comprising:
a tank structure;
at least first and second storage units arranged within the tank structure;
a collecting conduit; and
a tank outlet;
wherein the at least first and second storage units are each configured to store an extinguishing agent temporarily; wherein each of the at least first and second storage units comprises a primary portion and a secondary portion, wherein the secondary portion provides a tapering transition from the primary portion to a storage unit outlet;
wherein each of the storage unit outlets is connected to the collecting conduit configured to provide a flow of the extinguishing agent towards the tank outlet;
wherein the tank outlet is configured to discharge the extinguishing agent to a selected target; and
wherein adjacent primary portions of the at least first and second storage units are provided with a fluid connection.

2. The tank arrangement according to claim 1, further comprising, for the fluid connection, an adjustable separating rib between the adjacent primary portions of the at least first and second storage units.

3. The tank arrangement according to claim 2, wherein the adjustable separating rib is configured to be moveable by
i) translational movement; or
ii) pivoting movement.

4. The tank arrangement according to claim 1, wherein a shape of the primary portions is:
cylindrical, having a horizontal circular cross-section; or
angular, having flat surfaces meeting at distinct edges and vertices.

5. The tank arrangement according to claim 1, wherein the collecting conduit comprises a main pipe and a plurality of pipe segments,
wherein the plurality of pipe segments connects the storage unit outlets with the main pipe; and
wherein the collecting conduit comprises an outlet pipe segment connecting the main pipe with the tank outlet.

6. The tank arrangement according to claim 1, wherein the material of the storage unit and the collecting conduit is formed from aluminum or composite.

7. A fire-fighting aircraft comprising:
a fuselage structure; and
a fire-fighting tank arrangement according to claim 1;
wherein the fuselage structure encloses an inner space; and
wherein the fire-fighting tank arrangement is located in the inner space.

8. The fire-fighting aircraft according to claim 7, further comprising a wing box,
wherein the inner space comprises a floor separating a lower section located below the floor and an upper section located above the floor;
wherein the wing box is located in the lower section, and the tank arrangement is located in the upper section above the wing box;
wherein the collecting conduit of the tank arrangement is located in the upper section; and
wherein the tank arrangement is formed to have a shape of the upper section.

9. A method for building a fire-fighting aircraft, the method comprising:
loading a tank arrangement according to claim 1 into a fuselage of the fire-fighting aircraft;
arranging the tank arrangement in an upper section of the fuselage; and
installing the tank arrangement in the fire-fighting aircraft.

10. The method for extinguishing a fire using a fire-fighting aircraft according to claim 7, the method comprising:
identifying a fire location; and
during flight, discharging at least a part of an extinguishing agent stored in the at least first and second storage units through the collecting conduit and the tank outlet.
